(19) United States
(12) Patent Application Publication
(10) Pub. No.: US 2009/0122749 A1
(43) Pub. Date: May 14, 2009

(54) Method and apparatus for localizing AM/FM/XM radio advertisement

(76) Inventor: Joonbum Byun, Gaithersburg, MD (US)

Correspondence Address: R. J. LASKER, ESQ, 1199 NORTH FAIRFAX STREET, SUITE 900, ALEXANDRIA, VA, 22314, US

(21) Appl. No.: 11/984,090

(22) Filed: Nov. 13, 2007

(51) Int. Cl. H04Q 7/00

(52) U.S. Cl. 370/328

(57) ABSTRACT

Within a metropolitan area, existing AM/FM radio audience listens to same advertisement message at a time throughout the whole area. Such advertisement could be out of listener's interest if ad sponsor is located geographically far away from the listener. Business owner, such as auto dealer, restaurants or grocery store, may want to reach nearby local customer via radio advertisement. With this invention, radio broadcasting companies can air different advertisements at a time tailored to listeners in a specific sub-areas. They can air multiple advertisements simultaneously each of which is focused on local town or county listeners.

### BACKGROUND OF THE INVENTION

AM/FM radio broadcasting covers circular area of 40˜60 miles radius addressing usually one whole metropolitan area. Commercial advertisements, a main source of revenue for broadcasting company, are carried out to audience along with the program covering the same area. Regardless of the municipal, geographical and economical characteristics of a sub-region, identical advertisement messages are broadcasted over the whole area at one point of time.

For example, an auto dealer in an area advertises big sale event on a FM radio station. A listener, living about 50 miles away from the dealer, may decide not to visit the dealer because it is too far even though he/she is interested in the deal. As another example, let's say a non-franchised local restaurant would like to advertise their dinner special. Advertisement media they are afford to is local newspaper, banner or flier. It simply does not make economical sense for them to put such local restaurant ad broadcasted over a whole metropolitan area.

### FIELD OF INVENTION

The disclosed art multiplies available advertisement time over radio broadcasting station. Increased advertisement time will facilitate more business owner to put their ad on air and enables broadcasting company boost their revenue. It combines Internet and digital signal processing technology with existing radio broadcasting system by digitizing advertisement contents and transmitting them over public Internet.

### DESCRIPTION OF RELATED ART

Broadcast data radio system and receiver apparatus therefore U.S. Pat. No. 6,163,683. This prior provisioning localizes the commercials as well as the general program. It is practically not feasible to implement the method and apparatus as the existing radio receiver needs to be replaced with new one that can understand digital signal from local station.

Another prior art, Method and apparatus for customized rendering of commercials; U.S. Pat. No. 6,671,880, discloses on rendering selected commercials among received one. The selection is based on characteristics of the end user. Like the previous provisioning, the apparatus, radio or TV, must be smart enough to select the commercial, which requires replacement of existing one to make the art real.

### SUMMARY OF THE INVENTION

Current disclosure includes both a set of apparatus and advertisement business model that enables localized advertisement broadcasted via AM/FM/XM radio in highly economical way. Identical program is broadcasted throughout entire area a broadcasting company covers. But it is localized advertisement that is aired during the commercial break time. Many different advertisements from local business are aired, instead of one identical message propagated during the break.

This will benefit both radio broadcasting company and local business owners. The radio station will be able to increase revenue from commercial ad as they can air multiple messages at a time during a break. Instead of selling to one customer one block of commercial time during a specific time, it can sell multiple blocks to multiple ad sponsors. Rather than airing only one commercial at a time, the broadcaster can transmit up to several dozens of commercials at a time. The price for a localized commercial should be lower than that of general one. But total revenue from whole commercial is larger than that that could have earned from monotonic ad.

Through AM/FM radio broadcast, local business can reach their potential customers who used to be reachable only by local newspaper, banner, TV or flyer. Radio ad for local business is beyond their reach due to high advertisement cost and unnecessarily wide coverage area. If the disclosed apparatus and business model are put into service, they can post their ad on AM/FM/XM radio targeting geographically close customers with reasonable cost and successful penetration ratio.

To embody disclosed invention, current radio receiver can be used as is without any modification. The existing radio receiver must be used to listen to the program and the commercial ad because both of them are broadcast over carrier of same radio frequency. The only difference is the source of the radio wave. However, some changes are needed at central broadcasting station and branch stations need to be erected from scratch

### BRIEF DESCRIPTION OF DRAWING

FIG. 1 depicts the concept that whole coverage area 100 a broadcasting company serves is divided into multiple of sub-division 101 each of which is covered by unmanned branch broadcasting system 103.

FIG. 2 shows timing relation between general program 206 aired by central broadcasting station 202 and localized advertisement 200 aired by all the branch broadcasting station 203, 204 and 205. Each branch station transmits localized version of advertisement received from central station. General advertisement 201 covering whole area 100 is aired by central broadcasting station 202 just like general program 206.

FIG. 3 is a block diagram of unmanned branch broadcasting system. The computer system 301 communicates with central broadcasting station 102 through the public Internet 300. It receives advertisement contents from central station 102 and stores locally in digital format. When it receives command from central station 102 to air a specific advertisement, it retrieves corresponding contents from its local storage and forward it to AM/FM transmitter Interface 302, which converts digital to analogue signal. The transmitter 302 modulates the signal for AM/FM transmission and passes it to RF signal amplifier 303.

FIG. 4 displays exchange of messages between central broadcasting station 400, 102 and branch stations 402, 403, 103 through the public Internet 401. Branch stations 402, 403, when powered up, initialize connection with central station 400 by sending out message 404.

FIG. 5 illustrates architecture of a branch broadcasting system that supports multiples of central broadcasting companies with one branch broadcasting unit. The branch system communicates with multiples of central broadcasting system through the public Internet 500. It is configured to have IP (Internet Protocol) address of the central systems. Each broadcasting company owns its own AM/FM carrier frequency. So the branch system equipped with separate AM/FM transmitter interface 502 dedicated to each of the broadcasting company. The transmitter interface 502 modulates the analogue signal with carrier frequency owned by broadcasting company that sent the advertisement contents. More than one transmitter interface 502 enables the branch system to support multiple broadcasting companies.

The above objects, features and advantages of the invention are readily apparent from a consideration of the following description of the best mode of carrying out the invention when taken in conjunction with the following drawing representing a preferred embodiment of carrying out the invention

### DETAILED DESCRIPTION OF INVENTION

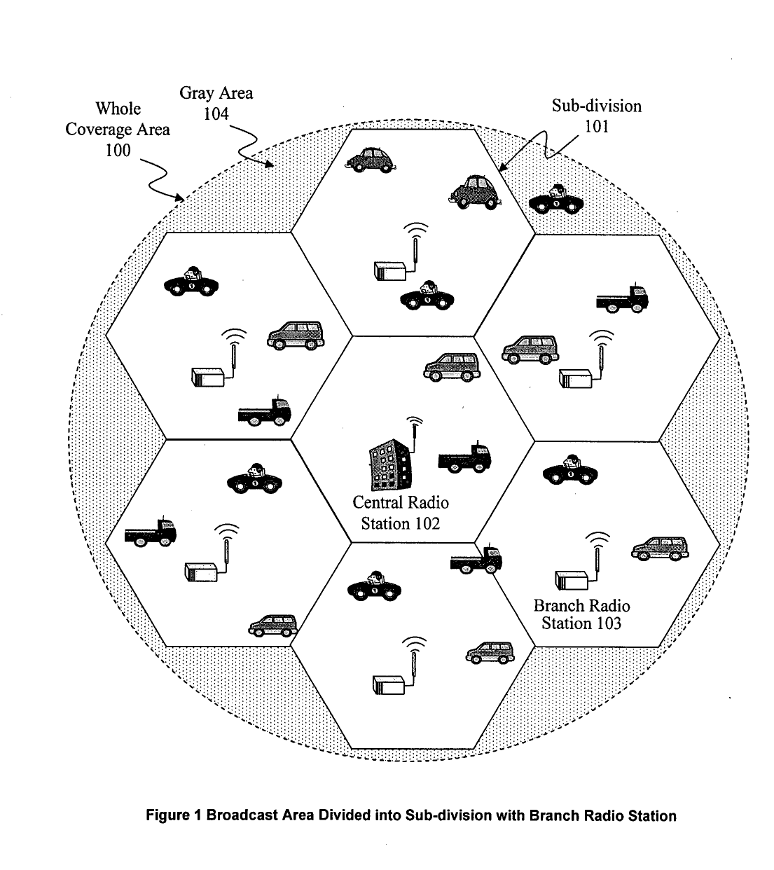

AM/FM radio broadcasting company usually covers an area of 40˜60 miles radius with one radio transmission antenna, where same programs and advertisement are provided throughout the area. The disclosed art segments the area into multiple of sub-division as shown in FIG. 1. The whole area 100 that used to be covered by one central station 102 is divided into number of sub-division 101. A branch radio station 103, located at geographical center of a sub-section, is put up to cover the each sub-division 101. Coverage area of radio wave is proportional to the transmission power of the wave. So, the area is divided into sub-division in such a way that radio wave from one branch station does not overlap with the one from neighboring sub-division.

The shaded region and boundary of each sub-division 101 in FIG. 1 is gray area, where radio wave from one branch station does not reach or may overlap with the one from neighboring sub-division. The radio listener within the area may receive very weak signal or overlapped one during only commercial break.

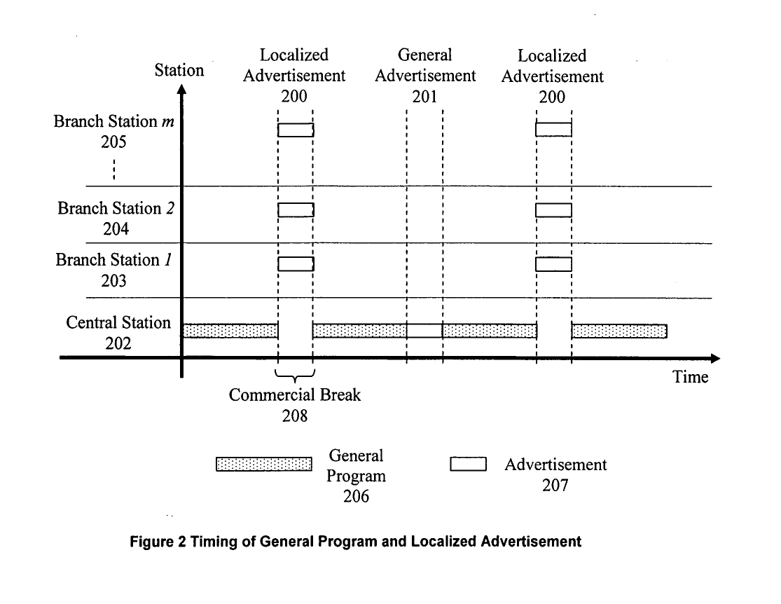

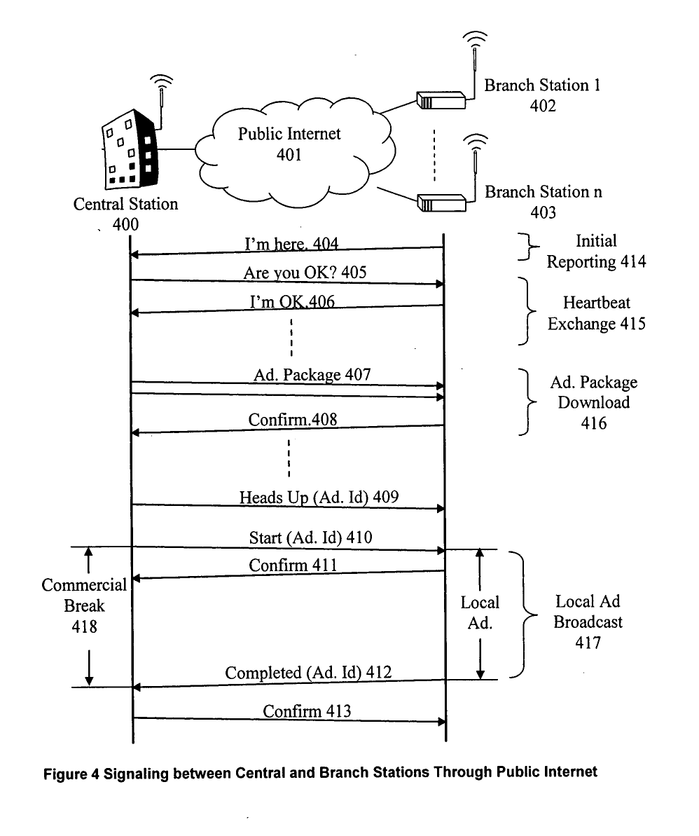

The art of mixing general program with localized multiple advertisement is disclosed. FIG. 2 shows timing synchronization of this concept. Central station 202 broadcasts general program 206 (dotted area) as it used to. It pauses to transmit radio signal during commercial break 208. The silence during the break is filled up by radio signals from all the local branch stations 103, 203, 205, 205 in each sub-division 101. During the time window 208, they start to broadcast their localized version of advertisement 200 addressing its sub-division 101. Branch radio station 103, 203, 204, 205 starts its broadcasting triggered by signal exchange through Internet. Length of all local advertisement is exactly same as the commercial break length 208. The branch radio station 103, 203, 204, 205 shares same carrier frequency as central station. More details on signaling are given in FIG. 4.

If there is a need to broadcast same advertisement throughout whole coverage area 100, central station does not trigger branch stations 103 to start transmission. Instead, it launches its general advertisement 201 covering entire region 100.

The contents of local advertisement are prepared by central station and sent to branch stations through Internet connection. Advertisement package for each branch station, containing branch station id, length, advertisement id and recorded audio advertisement to be broadcasted, are sent to branch station on-line through Internet wide area network (WAN). Once the package is ready, it is downloaded to branch station through Internet. Branch station stores the package in local storage that can be retrieved later identified by advertisement id. The length of all the local advertisement at a specific commercial break is same throughout the whole covered area.

The central station 202 pauses transmitting signals during the commercial break 208. During the silence, branch stations 203, 204, 205 instead, triggered by message from central station 202, start to air the stored advertisement contents 207. Once the commercial break 208 is over, central station 202 resumes transmitting the signal airing the general program 206.

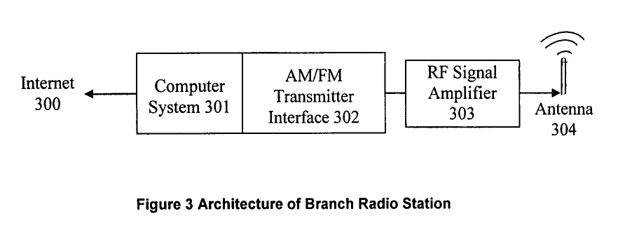

The branch radio station is an unmanned automated system. As shown in FIG. 3, it has two interfaces, Internet 300 and AM/FM radio transmission antenna 304. The computer system 301 receives through the Internet interface the advertisement package from the central station, unpacks it and program itself when and what to broadcast during the commercial break. A daemon program running in computer system make initial contact, responds to messages from central station server including heartbeat, advertisement package download, and start ad message. Branch station authenticates itself to central station before establishing a session with central station.

An advertisement package contains one or more of advertisement and each advertisement is composed of;
Station id: Id of the branch station airing the current advertisement
Advertisement Id: Uniquely identifies an advertisement
Recorded Audio Advertisement: Digital recording of local advertisement to be broadcast.
Length: Duration of the advertisement in seconds.

The package may be delivered whenever new advertisement is created or existing advertisement needs to be updated. Multiple advertisements are packed into one and sent to branch stations.

Central and branch station communicates via TCP/IP connection over Internet. Branch station is configured with IP address of central station server and initiates the connection first. The connection is one-to-one base between central and branch system. Heartbeat exchange, advertisement package download and advertisement synchronization takes place through the same communication channel.

By exchanging heartbeat message, server at central station continuously checks health of all of its branch stations as shown in FIG. 4. It periodically sends “Are you OK?” messages 405 and system at branch station 402, 403 responds to the message by returning “I'm OK” 406, if it is running OK. If it is down or out of order, central server at central station times out and regards the branch station as out of service. If branch station 402, 403 were to put out of service for scheduled maintenance, it reports to central server of its outage in advance. When a new ad package is ready for download, central server initiates download process to destined branch server.

For advertisement synchronization, central server at central station 400 sends “Heads Up” messages 409 to all branch stations 402 403 several tens of second in advance so that they can be prepared for. The message carries advertisement id to be aired. If branch station does not keep the recorded audio for the advertisement, it ask central server to download advertisement package.

At the moment when the commercial break starts, central server signals all the branch system to start their local advertisement with “Start” message 410, advertisement id and length. The signaling is not broadcast but one-to-one communication between central and branch systems. Upon receiving “Start” message 410, branch station 402, 403 broadcast its local advertisement 417, 217 specified in the message and sends confirmation 411 to central server. When the local advertisement 417, 200 is over, it reports to central server of the completion with “Completed” message 412 and server confirms. The signal delay between central sever and branch system, which is in order of mili-second, is neglected.

Many types of advertisement can be aired through the disclosed apparatus and method. Especially, the announcement, only meaningful to local community, is a good candidate that can be aired through the embodiment of current invention. Announcement from local municipality or schools, such as school closure, free concert, community gathering, town hall meeting notice and community events can be broadcast during the commercial break.

Rather than reporting traffic congested area to whole coverage area, local version of traffic report can be broadcast. It can describe the congestion in detail and length as local report can focus congested area of local significance.

There usually are a few dozens of AM/FM radio broadcasting company in a metropolitan area, city or town. They all use different carrier frequencies to broadcast their program and advertisement. To deploy current invention for multiple broadcasting companies, dedicated set of branch stations need to be deployed. If one branch system were to be designed to transmit only one carrier frequency signal, same number of branch station as the number of broadcasting company must be put up in a sub-division, which is highly non-economical.

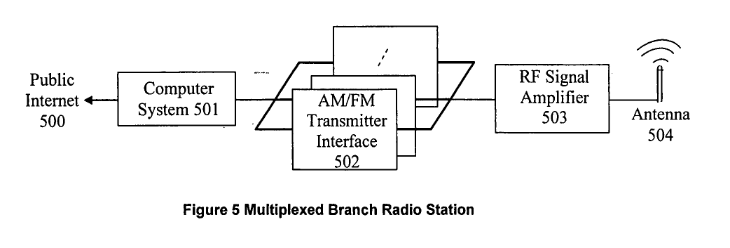

Current invention also discloses a system that can support multiple broadcasting companies with one branch station. As shown in FIG. 5, a computer system 501 has multiple AM/FM transmission interfaces 502. Each of the interfaces is capable of transmitting different carrier frequency. One interface is tuned to one broadcasting company's frequency and broadcasts the localized advertisement 417, 200 over carrier of the frequency. By having multiples of AM/FM transmission interface 501, one branch system support multiple of central broadcast station.

Based on the disclosed invention and its embodiment, a business model is disclosed that provides local advertisement service to radio broadcast company. If a broadcasting company were to provide local advertisement service using the embodiment, they need to purchase branch radio station system, rent a space that can populate the system with antenna and manage the equipment. Rather than each broadcast company deploys and manage their own branch station, it is far more economical to outsource them to a company that are specialized in providing the local ad service.

The service provider deploys branch station system to all of the sub-division in the whole coverage area. They solicit their service to all of broadcasters in a region. They can cut down capital and operational cost by providing the service to multiple broadcasters with one branch station system per a sub-division.

What is claimed is:

1. A radio broadcast system for broadcasting general radio programs and advertising, comprising:
at least one central radio broadcast system for broadcasting general radio program signals and radio advertising signals over a designated area;
at least one branch radio station for receiving said radio advertising signals in digital format via the internet and broadcasting only selected ones of said radio advertising signals over a limited area within said designated area, and;
said central radio broadcast system and said at least one branch radio station including means for communicating with one another via the internet to enable said central radio broadcast system to control the broadcasting of said selected ones of said advertising signals by said at least one branch radio station only during a commercial advertising break.

2. The radio broadcast system as claimed in claim 1, wherein said at least one branch radio station includes means for receiving and transmitting signals respectively from and to said at least one central broadcast system, an AM.LM transmitter interface, an RF signal amplifier responsive to said AM/FM transmitter interface, and an antenna for transmitting said advertising signals.

3. The radio broadcast system as claimed in claim 1, wherein the communication over the internet confirms at least the status of said at least one branch radio station, the actual advertising to be transmitted, the start of the transmission and confirmation of the start and finish of the transmitted advertising.

4. The radio broadcast system as claimed in claim 1, wherein said at least one branch radio station includes multiplexed AM/FM transmitter interfaces, an RF signal amplifier responsive to said multiplexed AM/FM transmitter interfaces, and an antenna for transmitting said advertising signals.
